(19) United States
(12) Patent Application Publication
(10) Pub. No.: US 2004/0090706 A1
(43) Pub. Date: May 13, 2004

(54) Method and apparatus for using vibration to clean a read/write head

(76) Inventors: Fred C. Thomas III, Ogden, UT (US); Christopher D. Hahm, Roy, UT (US)

Correspondence Address: T. Murray Smith, Esq., Baker Botts L.L.P., Suite 600, 2001 Ross Avenue, Dallas, TX, 75201-2980, US

(21) Appl. No.: 10/293,704

(22) Filed: Nov. 12, 2002

(51) Int. Cl. G11B 5/41

(52) U.S. Cl. 360/128

(57) ABSTRACT

A data storage apparatus (10) includes a drive (13) which can removably receive a cartridge (12) that contains a rotatable hard disk (17). The drive has a read/write head (38) supported for movement between a position adjacent an information storage surface (21) on the disk, and a position engaging a cleaning surface (52, 118) located within the drive. A vibrator (56, 112) effects vibration of the cleaning surface while it engages the head, in order to provide efficient and effective cleaning of an air bearing surface on the head, including shallow recesses of this surface.

### TECHNICAL FIELD OF THE INVENTION

This invention relates in general to techniques for increasing the storage density on a disk disposed in a removable cartridge and, more particularly, to techniques for cleaning a read/write head that transfers information to and from the disk.

### BACKGROUND OF THE INVENTION

Over the past twenty years, computer technology has evolved very rapidly. One aspect of this evolution has been a progressively growing demand for increased storage capacity in memory devices. In order to provide high storage densities at reasonable costs, one of the most enduring techniques has been to provide a rotatable hard disk having a layer of magnetic material thereon, in association with a read/write head supported for movement adjacent the disk.

In arrangements of this type, airborne dust, smoke, vapors and other contaminants can progressively build up on the head, until they interfere with the interaction between the head and disk, thereby increasing the error rate until the device will not operate. In order to avoid this problem, most hard disk drives have the disk and head disposed inside a sealed enclosure, so that the disk and head are not exposed to the airborne contaminants external to the enclosure.

This approach works well where the entire hard disk drive device is permanently installed in a computer. In other types of systems, however, a hard disk is provided in a removable cartridge, and it is desirable that the cartridge not include the read/write head. In this regard, there are advantages to placing a head stack assembly (HSA) and its support structure within the drive which receives the cartridge, rather than in the cartridge. For example, a typical user will have several removable cartridges for each drive. Thus, in terms of overall system cost, it is cheaper to put one head stack assembly with support structure in the drive, rather than to put a separate head stack assembly with support structure in each of the many cartridges used with that drive. But this presents problems in terms of keeping the head clean.

More specifically, in order to permit the head from the drive to access the disk within the cartridge, the cartridge is not provided with a sealed enclosure of the type discussed above. Instead, the cartridge is provided with a movable shutter which is opened when the cartridge is inserted into the drive, in order to give the head access to the disk. But when the shutter is open to give the head access to the interior of the cartridge, ambient air is also given access, along with any dust, smoke, vapor or other contaminant that it carries. Consequently, the operational surface of the head can relatively quickly develop a buildup of contaminants.

The effect of this buildup can be ameliorated to some extent by keeping the storage density on the hard disk in a removable cartridge at a relatively low level in comparison to the levels used for hard disks located within sealed enclosures. However, as mentioned above, the commercial marketplace is exhibiting a strong and progressively increasingly demand for high-density storage in a removable cartridge.

A further consideration is that existing high-density read/write heads typically have recesses in the operational surfaces thereof. While it is not too difficult to clean the outermost portions of the operational surface of such a head, it is more difficult to clean other portions of the surface which are in the form of shallow recesses, where contamination can easily collect and significantly degrade system operation.

### SUMMARY OF THE INVENTION

From the foregoing, it may be appreciated that a need has arisen for a method and apparatus for effectively and efficiently cleaning a head which moves relative to an information storage surface and effects transfers of information to or from the surface. According to the present invention, a method and apparatus are provided to address this need, and involve: positioning the head in a retracted position in which the head is spaced from the surface; causing the head, while in the retracted position, to engage a cleaning surface provided on a part; and effecting vibration of the part relative to the head while the head is in engagement with the cleaning surface.

### BRIEF DESCRIPTION OF THE DRAWINGS

A better understanding of the present invention will be realized from the detailed description which follows, taken in conjunction with the accompanying drawings, in which:

FIG. 1 is a diagram of an apparatus that embodies aspects of the present invention, including a removable cartridge which contains a hard disk, and including a drive which can receive the cartridge, which has a read/write head, and which has a mechanism for cleaning the head;

FIG. 2 is a diagrammatic view of an air bearing surface provided on the read/write head of FIG. 1;

FIG. 3 is diagrammatic perspective view of an apparatus which is an alternative embodiment of part of the apparatus of FIG. 1;

FIG. 4 is a flowchart showing one possible sequence for operating the apparatus of FIGS. 1 and 3; and

FIG. 5 is a graph showing how aspects of the present invention can reduce error rates in an apparatus of the type shown in FIG. 1.

### DETAILED DESCRIPTION OF THE INVENTION

FIG. 1 is a diagrammatic view of a data storage apparatus 10 which embodies aspects of the present invention. The apparatus 10 includes a data storage cartridge 12, which is removably inserted into a drive 13.

The cartridge 12 includes an information storage disk 17, which is mounted on a rotatably supported spindle 18. The spindle 18 is rotated by a not-illustrated motor, which is provided in the cartridge 12. Alternatively, the motor could be located in the drive 13, and could be drivingly coupled to the spindle 18 through a mechanical or magnetic coupling arrangement of a known type. The disk 17 has on one side thereof a surface 21 which is capable of storing information. In the embodiment of FIG. 1, the surface 21 is covered with a magnetic material. The disk 17 in FIG. 1 is a rigid component of the type commonly known as a hard disk. For purposes of convenience in explaining the present invention, it is assumed that there is one disk 17 and that information is stored on only one side thereof. However, persons skilled in the art will recognize that the disk could alternatively have information stored on both sides, and that there could be two or more of the disks 17 mounted on the spindle 18.

The drive 13 includes an actuator 31 which can effect pivotal movement of a shaft 32. An elongate actuator arm 33 is fixedly supported on and extends radially of the shaft 32. At the outer end of the arm 33, a suspension 37 supports a head stack assembly (HSA) which includes a read/write head 38. The suspension 37 is of a known type, and is therefore not described here in detail. The head 38 is also of a known type, and in FIG. 1 is a type of head known as a giant magnetoresistive (GMR) head. The head 38 has on a side facing the disk 17 a surface which is referred to in the art as an air bearing surface (ABS), and which is discussed in more detail later. The arm 33 and the suspension 37 support the head 38 so that the head is adjacent the surface 21 of the disk 17 during a portion of the pivotal movement of the arm 33. During this portion of the pivotal movement, the head 38 moves approximately radially of the disk 17, while remaining closely adjacent the surface 21. During normal operation, the disk 17 rotates at a relatively high rate of speed, causing a boundary layer of air located adjacent the disk to rotate with the disk. This moving air cooperates with the ABS on the head 38 in a known manner, causing the head 38 to float closely adjacent the disk on a cushion of air, without actually engaging the surface 21 of the disk.

The arm 33 can be pivoted by the actuator 31 to a retracted or park position, which is shown in broken lines in FIG. 1. In the park position, the arm 33 and head 38 are disposed within the drive 13, rather than within the removable cartridge 12. The housing of the cartridge 12 has an opening through which the head 38 and arm 33 can access the interior of the housing. When the cartridge 12 is withdrawn from the drive 13, a not-illustrated shutter on the housing moves to a position covering the opening in the housing. When the arm 33 is in the park position shown by broken lines in FIG. 1, it is supported by a not-illustrated ramp of a type well known in the art. Although the arm 33 is depicted in FIG. 1 as being supported for pivotal movement, it would alternatively be possible for the arm 33 to be supported for linear movement, for example in a direction approximately parallel to its length and approximately radially of the disk 17.

The drive 13 includes a cleaning part 51, which has thereon a cleaning surface 52. When the arm 33 is in the park position shown in broken lines in FIG. 1, the ABS on the head 38 engages the cleaning surface 52. In the embodiment of FIG. 1, the part 51 includes a piece of a velvet material, which has the cleaning surface thereon. The velvet is a polishing cloth material available under the trademark MICROCLOTH SUPREME® from Buehler, Ltd. of Lake Bluff, Ill., as catalog part number 40-7718.

The drive 13 includes a vibrator 56, which is operationally coupled to the part 51, so as to effect vibration of the part 51 when the vibrator 56 is energized. The vibrator is a device of a known type, and could include a piezoelectric element, a voice coil motor, or a standard motor driving a vibration mechanism that includes gears and/or cams. The vibrator 56 effects vibration of the part 51 at a frequency greater than approximately 20 Hz. In the embodiment of FIG. 1, the vibrator 56 effects vibration of the part 51 at a frequency of approximately 200 Hz. The vibrator 56 may alternatively be set to effect vibration of the part 51 at a frequency which effects resonant vibration of the fibers in the velvet material of the part 51, or to effect vibration in structure which movably supports the part 51, or in structure which supports the head 38, such as the suspension 37. In an alternative configuration, the vibrator 56 effects vibration of the part 51 at an ultrasonic frequency, or in other words a frequency in excess of 20 KHz. In still another configuration, the vibrator 56 effects vibration of the part 51 at two significantly different frequencies which are superimposed, such as frequencies of 300 Hz and 1.6 MHz.

The drive 13 includes an air pump 61 which, when energized, directs a jet of air toward the cleaning surface 52 through a tube 62. The drive 13 also includes a solvent dispenser 63 which, when energized, can deliver to the cleaning surface 52 through a tube 64 a small quantity of a well-known solvent.

A wiper motor 68 can effect pivotal movement of a shaft supporting a wiper 69. The wiper 69 is only pivoted when the head 38 is not engaged with the cleaning surface 52, or in other words when the head 38 is adjacent the surface 21 on the disk 17. When the motor 68 pivots the wiper 69, an edge of the wiper 69 is dragged or scraped across the cleaning surface 52, which tends to help clean the surface 52 by loosening contaminants and brushing them off this surface.

The drive 13 further includes an optical sensor 72, which is at a location where it is closely adjacent the arm 33 when the arm 33 is in the park position indicated by broken lines in FIG. 1. The optical sensor 72 is capable of detecting the proximity of the arm 33, or in other words whether the arm 33 is in the park position shown in broken lines, which indirectly represents a determination of whether the head 38 is currently engaging the cleaning surface 52.

The drive 13 includes a control circuit 76, which is responsive to an output signal from the optical sensor 72, and which can generate control signals for the vibrator 56, air pump 61, solvent dispenser 63, and wiper motor 68. In FIG. 1, the control circuit 76 also outputs signals which control the actuator 31, but it would alternatively be possible for the actuator 31 to be controlled by some other control circuit within the drive 13.

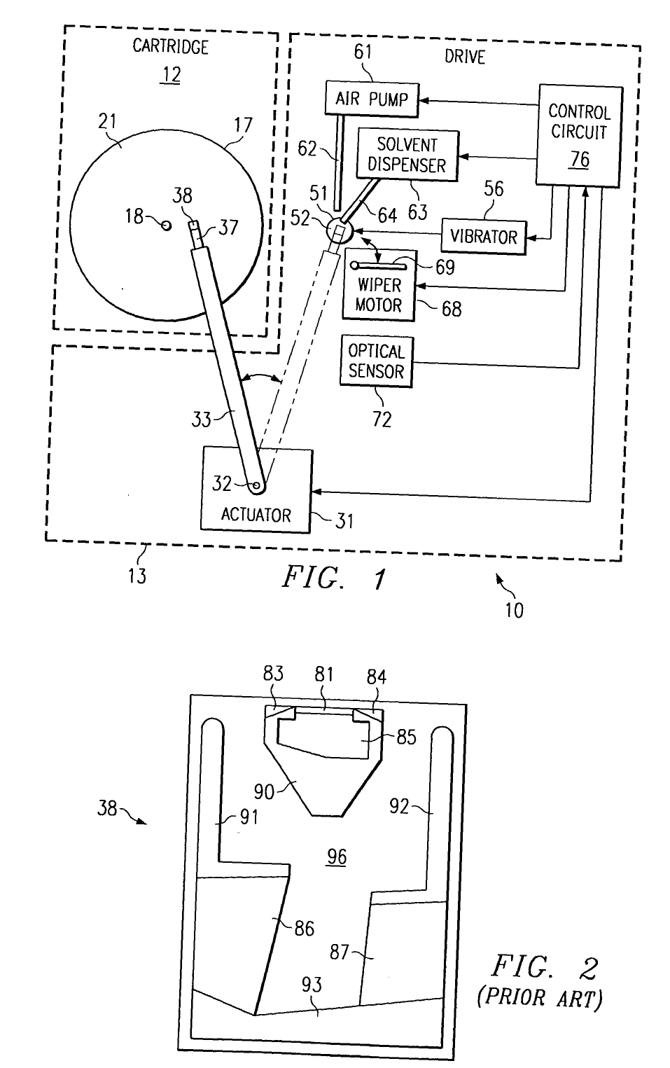

The operation of the apparatus 10 of FIG. 1 will be described in more detail later. First, the ABS on the head 38 will be described. In this regard, the head 38 used in the embodiment of FIG. 1 is a commercially available part, and FIG. 2 is a diagrammatic view of the ABS provided on the head 38. It should be noted that the overall surface is not smooth and continuous, but has some portions which are recessed. In more detail, reference numeral 81 designates a read/write element of the head 38, which is used to read and write information to and from the magnetic surface 21 on the disk 17. The highest or outermost portions of the ABS shown in FIG. 2 are the surface portions 85-87. These are the surface portions which are closest to the surface 21 of the disk during normal operational use.

Several additional surface portions 83-84 and 90-93 are recessed with respect to the surface portions 85-87, by a depth of approximately 200 nm. In FIG. 2, there is a line between each of the surface portions 83-84 and the surface portion 90, because the surface portions 83-84 are provided on one type of material and the surface portion 90 is provided on a different type of material. But the surface portions 83-84 and 90 are all recessed by the same amount with respect to the surface portions 85-87. The surface portion 96 represents an even deeper recess relative to the surface portions 85-87, and in particular has a depth of approximately 1,000 nm in relation to the surface portions 85-87.

The interaction between the head 38 and the hard disk 21 can be affected by airborne contaminants such as dust, smoke and vapors. As discussed above, the housing of the cartridge 12 has a not-illustrated shutter which can be moved to permit the head 38 to enter the interior of the cartridge, and this permits ambient air to also have access to the interior of the housing. While the level of contaminants within the interior of the cartridge 12 will typically be lower than that in the surrounding air, the level of contaminants can still be sufficiently high to permit a build-up of contaminants on the ABS surface of the head 38. In this regard, the most problematic areas tend to be the shallow recesses, corresponding to the surface portions indicated at 83-84 and 90-93 in FIG. 2. The outermost surface portions 85-87 are susceptible to a buildup of debris, but can be readily cleaned with any of a relatively wide variety of materials. Also, while debris may build up in the deep recess represented by surface portion 96, this recess is sufficiently deep so that a buildup of debris on surface portions 83-87 or 90-93 is more likely to cause problems before a buildup on surface portion 96 can cause a serious problem.

Debris which builds up in the shallow recesses defined by surface portions 83-84 and 90-93 can affect the air bearing cushion produced between the head and disk during normal operation, in a manner causing the head to be positioned nearer to or farther from the disk than it should be, thereby changing the space between the disk and the read/write element 81 to be different from what it is designed to be, which in turn interferes with the ability of the element 81 to accurately read data from and write data to the disk. The apparatus 10 of FIG. 1 is configured to effect reliable and efficient cleaning of the deep and shallow recesses represented by surface portions 83-84, 90-93 and 96, as explained later.

As discussed above, the cleaning surface 52 in the embodiment of FIG. 1 is a velvet material. However, this cleaning surface could alternatively be almost any other suitable type of material. As one example, it could be provided on a textured ceramic material, or a textured glass material. One suitable form of such a textured glass material is commercially available from Physical Optics Corporation of Torrance, Calif. as a 5° Sol-gel Holographic White Light Shaping Diffuser (LSD). As is known in the art, sol-gel is composed of silica suspended in a polymeric matrix. Heat treatment or hard ultraviolet exposure drives off most of the organic component, leaving a hard, glassy surface. Embossing of sol-gel is carried out under high pressure, and can produce features with heights up to several microns. The features embossed into the sol-gel can, for example, make up a hologram. In the particular exemplary material discussed here, these features include a hologram with a somewhat random arrangement of peaks and valleys having a maximum peak-to-valley height of about 2 microns (2,000 nm). The peaks have a relatively large radius of curvature of about 30 microns, which is believed to reduce the likelihood that a peak will fracture while it is being rubbed against the read/write head 38.

Still another approach would be to provide a cleaning surface by chemically etching a glass material. The chemical etching can be carried out using solutions of various etchants, such as hydrofluoric acid and/or an etchant commercially available under the tradename ETCHALL from B&B Etching Products, Inc. of Sun City, Ariz. By using these etchants in combination with printed circuit board layout and etching equipment, the base texture surface of a textured glass material could have superimposed thereon a relief pattern selected from a variety of different geometries, one example of which is a microscopic washboard pattern having spatially separated stripes.

In the embodiment of FIG. 1, the part 51 has a single cleaning surface 52. In a variation of the embodiment of FIG. 1, which is not separately illustrated, the part 51 is about twice as large as shown in FIG. 1, and has two separate cleaning surfaces thereon. One is the same velvet material used for the cleaning surface 52 in FIG. 1, and the other is a coarser material, for example a textured glass material of the type just described. In this embodiment, the arm 33 would have two different park positions arranged at a small angle to each other, where the head 38 engages the velvet cleaning surface when the arm 33 is in one of its park positions, and engages the textured glass cleaning surface when the arm 33 is in the other of its park positions. The actuator 31 would control which of the two park positions the arm 33 is moved to. The optical sensor 72 could be used to detect both positions of the arm 33, in order to facilitate accurate positioning of the arm 33 in each position.

In this regard, the arm 33 would normally be moved to a position in which the head 38 is engaging the velvet cleaning surface, so that the velvet cleaning surface would be used to clean the head 38. However, at infrequent intervals, the arm 33 would be moved to its other park position, so that the textured glass cleaning surface would be used to clean the head 38. Since the textured glass cleaning surface is more abrasive than the velvet material, it would provide more effective cleaning, but it would also have a greater tendency to abrade the head 38. Thus, the velvet material would be used for routine cleaning, and the textured glass cleaning surface would be used on an infrequent basis for more thorough cleaning.

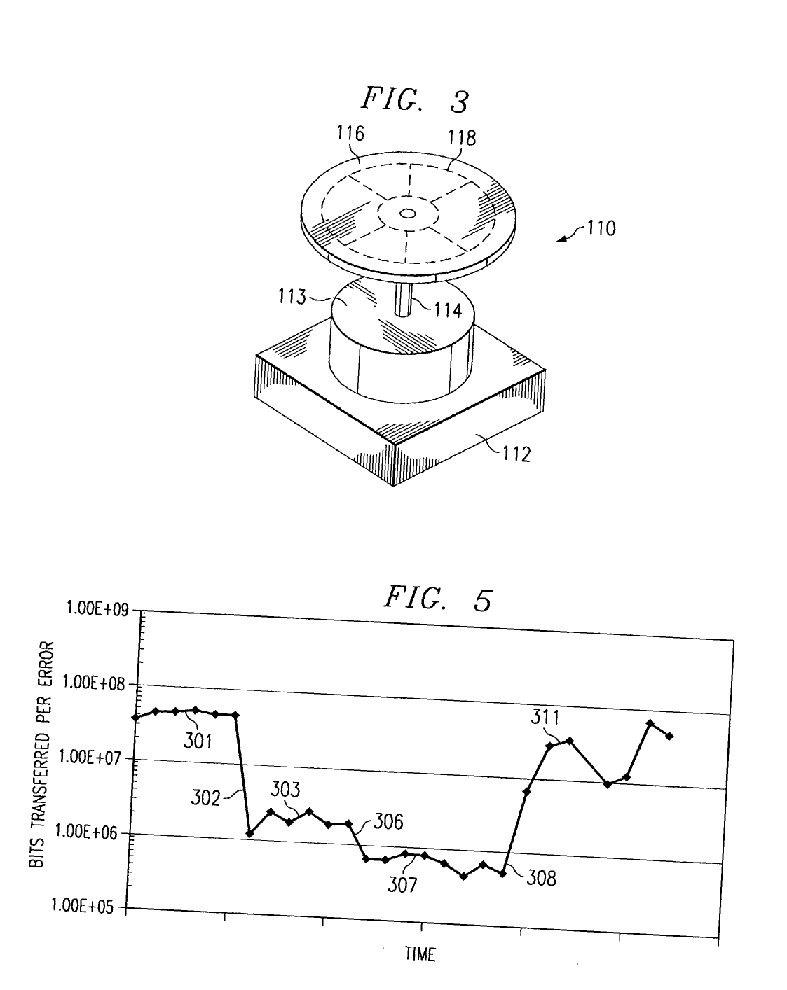

FIG. 3 is diagrammatic perspective view of an apparatus 110 which is an alternative embodiment of the vibrator 56 and part 51 in FIG. 1, and which can be substituted for the vibrator 56 and part 51. The apparatus 110 includes a vibrator 112 which supports a stepper motor 113. The stepper motor 113 has a rotatable shaft 114, which supports a disk-shaped part 116. The part 116 has on an upper side thereof an annular cleaning region 118. In FIG. 3, the cleaning region 118 is depicted as having six sector-shaped portions which each constitute a cleaning surface that is functionally comparable to the cleaning surface 52 of FIG. 1.

The entire upper surface of this disk-shaped part 116 may be covered with a single material, such as the velvet material discussed above in association with the part 51, so that each of the six cleaning surfaces of the cleaning region 118 are all identical. In that case, one of the sector-shaped cleaning surfaces shown in FIG. 3 can be repeatedly used for cleaning the head 38 (FIG. 1), until that sector shaped cleaning surface becomes too worn or dirty, at which point the stepper motor 113 can be used to rotate the disk 116 by 60°, so as to bring an equivalent but “fresh” sector-shaped cleaning surface into position for engagement with the head 38.

Alternatively, instead of providing the same material on the entire upper surface of the disk-shaped part 116, several different materials could be provided, so that each of the six sector-shaped cleaning surfaces of the cleaning region 118 is defined by a respective different type of material. Some or all of these materials may be different grades of the same material, such as different grades of velvet. Alternatively, they may be entirely different materials. For example, they may be selected from materials such as velvet, felt or some other fabric, or they may be selected from more rigid materials with textured surfaces, such as ceramic, glass, plastic or metal. Surface texturing can be effected using known techniques, such as wafer texturing, mechanical texturing, or sol-gel texturing.

Materials which respond to engagement with the head 38 by changing shape to some extent, in order to conform to the shape of the head, are referred to herein as compliant materials. More rigid materials, which do not change shape in order to conform to the shape of the head, are referred to herein as non-compliant materials. Where different materials are used for different sector-shaped cleaning surfaces in the annular region 118 of FIG. 3, it is possible to begin a head cleaning procedure with a relatively soft and compliant material. If this material results in adequate cleaning of the head, then the cleaning procedure can be terminated. On the other hand, it the initial material does not adequately clean the head, one or more other materials can be tried in succession, including materials which are less compliant or even non-compliant.

Although FIG. 3 depicts the cleaning region 118 as an annular region provided on a rotatable disk-like part 116, it will be recognized that there are other ways to configure this cleaning region. For example, an elongate strip of material could be provided, with the cleaning region formed by a series of adjacent cleaning surfaces that extend along one side of the strip. The strip could have opposite ends wound on respective cylindrical rollers that can be rotated by one or more stepper motors, in order to effect lengthwise movement of the strip.

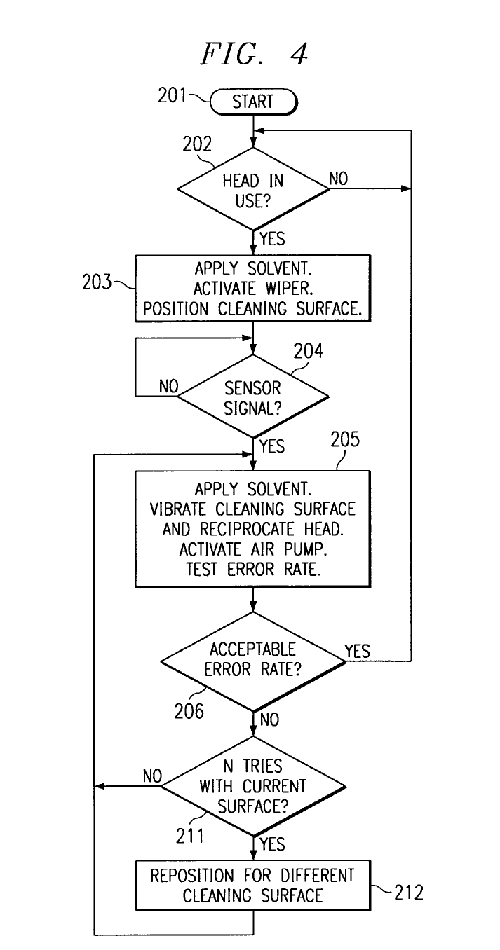

There are a variety of different ways to operate the apparatus shown in FIG. 1. FIG. 4 is a flowchart showing one exemplary way of operating this apparatus. For purposes of discussing FIG. 4, it is assumed that the apparatus 110 of FIG. 3 has been substituted for the vibrator 56 and part 51 in FIG. 1.

In the flowchart of FIG. 4, execution begins at block 201. At block 202, the control circuit 76 checks to see whether the head 38 is in use, or in other words whether the head 38 is adjacent the surface 21 of the disk 17. If the head 38 is adjacent the surface 21, then the head 38 and arm 33 will be spaced from the park position shown in broken lines in FIG. 1. If the head is currently in use, control proceeds to block 203. If the head is not currently in use, the system waits at block 202 for a point in time at which the head is put into use, and then proceeds to block 203.

At block 203, the control circuit 76 causes the solvent dispenser 63 to dispense a small quantity of a solvent onto a selected one of the cleaning surfaces in the region 118 (FIG. 3), which is the cleaning surface that is expected to be used to engage and clean the head 38 when the head 38 next returns to its park position. Then, the wiper motor 68 is activated, and pivots the wiper 69 approximately 180° counterclockwise, so that it slides across the selected cleaning surface and removes dirt and contaminants that may be present on the selected cleaning surface. The presence of the solvent on the surface is optional, but it can help to remove dirt and contaminants. Then, if the selected cleaning surface is not already positioned where it will engage the head 38 when the head moves back to its park position, the stepper motor 113 is used to properly position the selected cleaning surface for engagement with the head. Control then proceeds to block 204.

At block 204, the control circuit 76 checks the output of the optical sensor 72, to see if the arm 33 has moved to the park position shown in broken lines in FIG. 1. If not, the control circuit 76 waits in block 204 for the head 38 and arm 33 to move back to the park position. Once the arm 33 and head 38 are back in the park position, control proceeds to block 205.

In block 205, the solvent dispenser 63 can be activated again to apply another small quantity of solvent to the cleaning surface. In block 203, solvent was applied to facilitate cleaning of the cleaning surface itself. In block 205, solvent is applied primarily to help remove material from the ABS of the head 38. Next, the control circuit 76 activates the vibrator 112 for a predetermined time interval of about 1-5 seconds. It will be recognized that this time interval could alternatively be longer or shorter.

In the embodiment discussed here, the vibration movement includes a two-dimensional orbital movement, where each point on the cleaning surface moves approximately in a circle within the plane of the cleaning surface. Alternatively, the vibration movement may also include a movement component in the third dimension, or in other words movement perpendicular to the plane of the cleaning surface. Still another alternative would be to effect vibration through linear reciprocation in a selected direction.

As discussed above, in a situation where the cleaning surface is a compliment material such as velvet, the frequency of vibration is selected so as to effect a degree of resonant movement of fibers within the material. Alternatively, this could involve resonant vibration of structure supporting either the head or the cleaning surface. Such resonant vibration effects a degree of amplification in the vibration energy imparted to the interaction of the head and cleaning surface. Further, with respect to fibers of the material defining the cleaning surface, the resonant vibration promotes entry of these fibers into the recesses of the head, in order to facilitate efficient and effective cleaning of the surfaces 83-84, 90-93 and 96 which define these recesses.

While the vibrator 112 is vibrating the cleaning surface that engages the head 38, the actuator 31 can optionally be controlled so as to reciprocate the arm 33 through a very small angle that keeps the head 38 in engagement with the cleaning surface. The frequency of this reciprocation of the arm 33 is selected to be substantially lower than the frequency at which the cleaning surface is being vibrated by the vibrator 112.

At the end of the predetermined time interval, the vibrator 112 is turned off, and reciprocating movement of the arm 33 is terminated. A control circuit 76 briefly activates the air pump 61, in order to shoot a jet of air across the cleaning surface and the head 38. This facilitates the removal of loose material from both the ABS on the head 38, and also the cleaning surface.

Next, the control circuit 76 determines an error rate. This is carried out by using the head 38 to write test data at several predetermined and reserved locations scattered across the surface 21 of the disk 17, and to then read back the same information and check it for accuracy. The results of this activity are used to calculate an error rate of a known type, for example by calculating the number of bits transferred between errors, where a high value represents a low error rate and a low value represents a high error rate.

At block 206, the control circuit 76 evaluates whether the calculated error rate is acceptably low. If it is, then the cleaning procedure terminates, and control returns to block 202. On the other hand, if the error rate is too high, control proceeds from block 206 to block 211, where the control circuit 76 checks to see whether the current cleaning procedure has involved N successive attempts to clean the head using the current cleaning surface, where N is a small integer. If not, then control proceeds to block 205 to make a further attempt to clean the head using the current cleaning surface. Otherwise, control proceeds from block 211 to block 212, where the stepper motor 113 is operated to rotate the disk-shaped part 116, so that a different cleaning surface is moved into position for engagement with the head 38. This newly selected cleaning surface may be a cleaner piece of the same material that defined the original cleaning surface. Alternatively, this cleaning surface may be an entirely different material. From block 212, control returns to block 205 for an attempt to clean the head using the new cleaning surface.

FIG. 5 is a graph showing some measured results for an actual system with a cleaning system configured to vibrate a head cleaning surface relative to a head in a manner conforming to principles of the present invention. In FIG. 5, the vertical axis represents a measurement of the amount of data transferred between successive errors. Thus, higher values on the vertical axis are desirable because they represent fewer errors. During initial operation at 301, very few errors were experienced. Then, at 302, smoke was introduced into the interior of the cartridge housing, resulting in a buildup of some contaminants on the ABS of the read/write head. As a result, the rate of errors increase significantly, as evident at 303. Subsequently, smoke was again introduced into the cartridge housing at 306. This resulted in a further increase in errors, as evident at 307. Then, at 308, the cleaning system was used to clean the head according to principles of the present invention, including five successive vibration intervals using a velvet material of the type identified earlier. It will be noted that there was a prompt and significant reduction in the number of errors, as evident at 311.

The present invention provides a number of technical advantages. One such technical advantage is that a contaminated read/write head can be efficiently and effectively cleaned through vibration of a cleaning surface which engages the head. This makes it practical to implement a relatively high density hard disk in a removable cartridge, while putting the read/write head in the drive, and without a significant need to seal the cartridge. As one example, it is possible to implement a removable cartridge containing a single low-cost 2.5″ disk which reliably achieves a capacity of 10 GB or more, or in other words an aerial density greater than 17.5 GB per square inch. The techniques according to the invention are especially advantageous for cleaning shallow recesses in a head.

Although selected embodiments have been illustrated and described in detail, it should be understood that various substitutions and alterations can be made therein without departing from the spirit and scope of the present invention, as defined by the following claims.

What is claimed is:

1. An apparatus, comprising:
an information storage medium having an information storage surface thereon;
structure which can effect a transfer of information with respect to said surface, including a head operable to effect at least one of reading information from and writing information to said surface, said head and said storage medium being supported for relative movement in a manner causing said head to move with respect to said surface while remaining adjacent thereto, said structure including an actuator which controls at least one component of said movement of said head relative to said surface, said head being movable to a retracted position in which said head is spaced from said surface; and
a head cleaning mechanism, including a part having thereon a cleaning surface which is engageable with said head when said head is in said retracted position, and a vibration section which can effect vibration of said part relative to said head while said head is in contact with said cleaning surface.

2. An apparatus according to claim 1, wherein said vibration section vibrates said part at a frequency greater than 20 Hz.

3. An apparatus according to claim 2, wherein said vibration section vibrates said part at a frequency which is ultrasonic.

4. An apparatus according to claim 1, wherein said vibration section vibrates said part at two substantially different frequencies at the same time.

5. An apparatus according to claim 1, wherein said actuator effects reciprocal movement of said head relative to said part while said vibration section is effecting vibration of said head.

6. An apparatus according to claim 5, wherein said vibration section effects vibration of said part at a frequency which is substantially greater than a frequency at which said actuator reciprocated said head.

7. An apparatus according to claim 1, wherein said vibration section effects vibration of said part in a manner involving two-dimensional movement of said part.

8. An apparatus according to claim 7, wherein said vibration section effects approximately circular movement of said part.

9. An apparatus according to claim 1, wherein said vibration section effects vibration of said part in a manner involving three-dimensional movement of said part.

10. An apparatus according to claim 1, wherein said vibration section effects movement of said part at a frequency which effects resonance in structure of said cleaning surface.

11. An apparatus according to claim 1, wherein said vibration section effects movement of said part at a frequency which effects resonance in structure supporting one of said part and said head.

12. An apparatus according to claim 1, wherein said cleaning surface has first and second portions, and wherein said head cleaning mechanism is operable to effect selective positioning of said head and said part so that a selected one of said first and second portions is engageable with said head.

13. An apparatus according to claim 12, wherein head cleaning mechanism effects said selective positioning by causing said actuator to move said head relative to said part to one of said first and second positions.

14. An apparatus according to claim 12, wherein head cleaning mechanism includes a part positioning mechanism which is operable to effect said selective positioning by moving said part relative to said head to one of said first and second portions.

15. An apparatus according to claim 12, wherein said first and second portions of said cleaning surface have different characteristics.

16. An apparatus according to claim 1, wherein said head cleaning mechanism includes a surface cleaning mechanism for cleaning said cleaning surface.

17. An apparatus according to claim 16, wherein said surface cleaning mechanism includes a selectively source of pressurized gas which is configured to direct a stream of gas toward said cleaning surface.

18. An apparatus according to claim 16, wherein said surface cleaning mechanism includes a surface cleaning part which is physically engageable with said cleaning surface to facilitate cleaning thereof.

19. An apparatus according to claim 16, including a supply arrangement for selectively applying a solvent to said cleaning surface.

20. An apparatus according to claim 1, wherein said part includes a compliant material which has said cleaning surface thereon.

21. An apparatus according to claim 1, wherein part includes a non-compliant material having said cleaning surface thereon.

22. An apparatus according to claim 1, wherein said part having said cleaning surface thereon is made from a velvet material.

23. An apparatus according to claim 1, wherein said part having said cleaning surface thereon is made from one of a textured glass material and a textured ceramic material.

24. An apparatus according to claim 23, wherein said one of said textured glass material and said textured glass material has a relief pattern superimposed on the texture characteristic thereof.

25. A method for cleaning a head which is supported for movement adjacent and relative to an information storage surface provided on an information storage medium, and which is operable to effect at least one of reading information from and writing information to said surface, comprising the steps of:
positioning said head in a retracted position in which said head is spaced from said surface;
causing said head, while in said retracted position, to engage a cleaning surface provided on a part; and
effecting vibration of said part relative to said head while said head is in engagement with said cleaning surface.

26. A method according to claim 25, wherein said step of effecting vibration is carried out be effecting said vibration at a frequency greater than 20 Hz.

27. A method according to claim 26, wherein said step of effecting vibration is carried out be effecting said vibration at a frequency which is ultrasonic.

28. A method according to claim 25, wherein said step of effecting vibration is carried out by vibrating said part at two substantially different frequencies at the same time.

29. A method according to claim 25, including the step of effecting reciprocal movement of said head relative to said part while said vibration section is effecting vibration of said head.

30. A method according to claim 29, wherein said step of effecting reciprocal movement is carried out by effecting said reciprocal movement at a frequency which is substantially less than a frequency at which said part is being vibrated.

31. A method according to claim 25, wherein said step of effecting vibration includes the step of effecting said vibration at a frequency which effects resonance in structure of said cleaning surface.

31. A method according to claim 25, wherein said step of effecting vibration includes the step of effecting said vibration at a frequency which effects resonance in structure supporting one of said part and said head.

32. A method according to claim 25, including the steps of providing first and second cleaning surfaces, and selecting one of said first and second cleaning surfaces to be said cleaning surface which engages said head.

33. A method according to claim 32, including the step of configuring said first and second cleaning surfaces to have different characteristics.

35. A method according to claim 25, including the step of cleaning said cleaning surface.

36. A method according to claim 35, wherein said step of cleaning said cleaning surface includes the step of directing a stream of a gas toward said cleaning surface.

37. A method according to claim 35, wherein said step of cleaning said cleaning surface includes the step of causing a cleaning part to engage said cleaning surface while moving relative thereto.

38. A method according to claim 25, including the step of selectively supplying a solvent to said cleaning surface.
